(19) United States
(12) Patent Application Publication
(10) Pub. No.: US 2006/0047409 A1
(43) Pub. Date: Mar. 2, 2006

(54) Traveling control device of vehicle

(75) Inventor: Takuji Oka, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Hiroshima (JP)

(21) Appl. No.: 11/167,262

(22) Filed: Jun. 28, 2005

(30) Foreign Application Priority Data
Sep. 1, 2004 (JP) 2004-254602

(51) Int. Cl. G08G 1/00

(52) U.S. Cl. 701/117

(57) ABSTRACT

At first, it is determined whether or not the own vehicle travels in the auto-cruising mode. When the answer is YES, it is determined whether or not the traffic congestion occurs on the next lane. When the answer is YES, the set speed is reduced and the actuators to adjust the throttle and brake are controlled respectively so as to maintain the vehicle speed at the reduced set speed. Thereby, the own vehicle travels at the constant speed of the reduced set speed. Accordingly, the own vehicle's crash against the cutting-into vehicle from the next lane when the traffic congestion occurs on the next lane can be properly avoided without operating the accelerator, brake, or steering handle.

### BACKGROUND OF THE INVENTION

The present invention relates a traveling control device of a vehicle.

Conventionally, a traveling control device of a vehicle, which performs on a highway or the like an auto-cruising control to adjust a vehicle speed of an own vehicle at a constant speed or a following-traveling control to adjust the own vehicle's speed so as to control a vehicle-to-vehicle distance between the own vehicle and a vehicle traveling in front of the own vehicle at a target vehicle-to-vehicle distance, is known. For example, Japanese Patent Laid-Open Publication No. 2004-38861 discloses the traveling control device of a vehicle which performs the following-traveling control, in which when a traffic congestion occurs on a traveling lane of the own vehicle, the target vehicle-to-vehicle distance is changed.

Generally, when the traffic congestion occurs on another lane next to the own vehicle's traveling lane, other vehicles traveling on the next lane sometimes cut into the traveling lane of the own vehicle to get out of the traffic congestion. Accordingly, it is preferable that the above-described traveling control device of a vehicle is constituted so as to avoid a crash against such vehicles cutting into in front of the own vehicle, without operating the accelerator, brake, or steering handle, when the traffic congestion occurs on the next lane.

### SUMMARY OF THE INVENTION

The present invention has been devised in view of the above-described problem, and an object of the present invention is to provide a traveling control device of a vehicle equipped with a vehicle speed control device operative to control the vehicle speed of the own vehicle so as to be set at a specified vehicle speed, which can properly avoid the crash against the cutting-into vehicle from the next lane, without operating the accelerator, brake, or steering handle, when the traffic congestion occurs on the next lane.

According to the present invention, there is provided a traveling control device of a vehicle, comprising a vehicle speed control device operative to control a vehicle speed of an own vehicle so as to be set at a specified vehicle speed, a traffic congestion determining device operative to determine whether a traffic congestion occurs or not on a lane which is next to a traveling lane of the own vehicle, and an adjusting device operative to reduce the specified vehicle speed controlled by the vehicle speed control device when it is determined by the traffic congestion determining device that the traffic congestion occurs on the next lane.

Accordingly, since the adjusting device reduces the specified vehicle speed controlled by the vehicle speed control device when it is determined by the traffic congestion determining device that the traffic congestion occurs on the next lane, the vehicle speed control device controls the own vehicle's speed at the reduced specified vehicle speed. Thus, the crash against the cutting-into vehicle from the next lane can be properly avoided without operating the accelerator, brake, or steering handle, when the vehicle speed control device controls the own vehicle's speed and the traffic congestion occurs on the next lane.

According to a preferred embodiment of the present invention, there is further provided a cutting-into probability calculating device which calculates a probability of another vehicle traveling on the next lane cutting into the traveling lane of the own vehicle when it is determined by the traffic congestion determining device that the traffic congestion occurs on the next lane, wherein the adjusting device is constituted so as to reduce the specified vehicle speed controlled by the vehicle speed control device based on the probability calculated by the cutting-into probability calculating device when it is determined by the traffic congestion determining device that the traffic congestion occurs on the next lane.

Generally, the probability of another vehicle traveling cutting into the own vehicle's traveling lane from the next lane with the traffic congestion is considered influenced by the driver's mental state.

According to the above-described preferred embodiment, the cutting-into probability calculating device calculates the probability of another vehicle traveling on the next lane cutting into the own vehicle's traveling lane when it is determined by the traffic congestion determining device that the traffic congestion occurs on the next lane, and the adjusting device reduces the specified vehicle speed controlled by the vehicle speed control device based on the probability calculated by the cutting-into probability calculating device when it is determined by the traffic congestion determining device that the traffic congestion occurs on the next lane. Accordingly, the vehicle speed control device can perform the vehicle speed control which is suitable to the driver's mental state of the vehicle traveling on the next lane with the traffic congestion.

According to another preferred embodiment of the present invention, the vehicle speed control device is constituted so as to control the own vehicle's speed at a target vehicle speed which is set as the specified vehicle speed.

Accordingly, the present invention can be properly applied to the device which performs the so-called auto-cruising control enabling the driver's non-operation of the accelerator or the brake.

According to another preferred embodiment of the present invention, the vehicle speed control device is constituted so as to control the own vehicle's speed in such a manner that a vehicle-to-vehicle distance between the own vehicle and a vehicle which travels on the same lane and in front of the own vehicle is equal to a target vehicle-to-vehicle distance.

Accordingly, the present invention can be properly applied to the device which performs the so-called following-traveling control enabling the driver's non-operation of the accelerator or the brake.

According to another preferred embodiment of the present invention, the cutting-into probability calculating device is constituted so as to calculate the probability based on a distance of the traffic congestion on the next lane.

Accordingly, an appropriate control of the cutting-into probability calculating device can be attained.

According to another preferred embodiment of the present invention, the cutting-into probability calculating device is constituted so as to calculate the probability based on a time elapsed after the traffic congestion has occurred on the next lane.

Accordingly, another appropriate control of the cutting-into probability calculating device can be attained.

According to another preferred embodiment of the present invention, the cutting-into probability calculating device is constituted so as to calculate the probability based on a speed difference between the own vehicle's speed and a peed of the another vehicle traveling on the next lane.

Accordingly, another appropriate control of the cutting-into probability calculating device can be attained.

According to another preferred embodiment of the present invention, the cutting-into probability calculating device is constituted so as to calculate the probability based on a vehicle-to-vehicle distance between the own vehicle and a vehicle which travels on the same lane and in front of the own vehicle.

Accordingly, another appropriate control of the cutting-into probability calculating device can be attained.

Other features, aspects, and advantages of the present invention will become apparent from the following description which refers to the accompanying drawings.

### BRIEF DESCRIPTION OF THE DRAWINGS

FIG. 1 is a diagram showing a scene of a vehicle traveling on a highway at around an interchange according to an embodiment of the present invention.

FIG. 2 is a block diagram of a traveling control device of a vehicle.

FIG. 3 is a flowchart of control processing of the traveling control device of a vehicle.

FIG. 4 is a flowchart of control processing of the traveling control device of a vehicle.

FIG. 5 is a flowchart of control processing of the traveling control device of a vehicle.

### DETAILED DESCRIPTION OF THE INVENTION

Hereinafter, preferred embodiments of the present invention will be described referring to the accompanying drawings. It should be understood that even though embodiments are separately described, single features thereof may be combined to additional embodiments.

### Embodiment 1

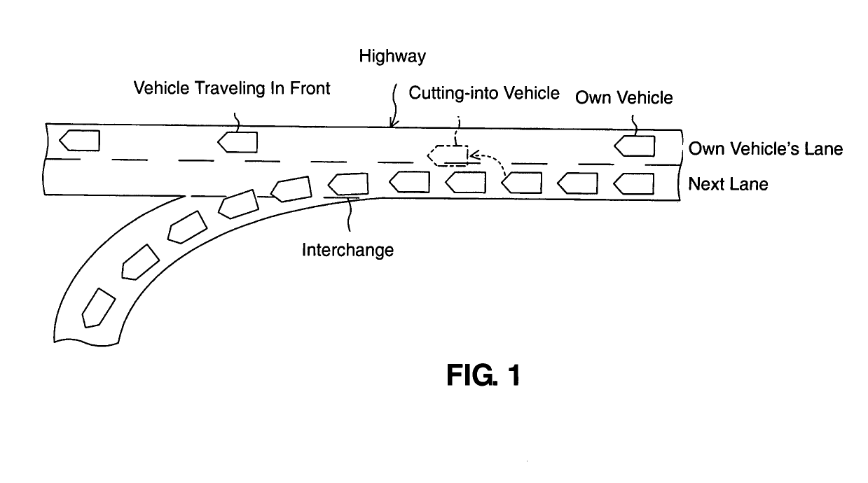

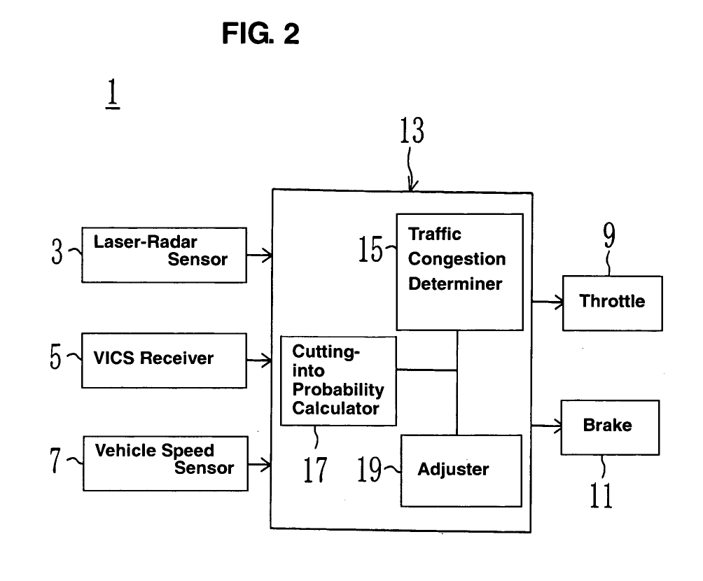

A traveling control device 1 according to a preferred embodiment of the present invention performs its appropriate control when a vehicle (hereinafter, referred to as “own vehicle”) travels on a specified lane of a highway having plural lanes, especially at around an interchange of the highway, as shown in FIG. 1 (the highway having two lanes in the same direction in the figure). As shown in FIGS. 1 and 2, the traveling control device 1 comprises a laser-radar sensor 3 operative to detect a vehicle-to-vehicle distance between the own vehicle and a vehicle traveling in front of the own vehicle, a relative speed between the own vehicle's speed and a vehicle speed of another vehicle traveling on a lane next to the own vehicle's traveling lane, a receiver 5 for VICS (the road traffic information communication system) to receive road-traffic information including a traffic congestion, a vehicle speed sensor 7 operative to detect the own vehicle's speed, a throttle 9, a brake 11, and a controller 13 operative to perform some controls. The above-described vehicle traveling in front of the own vehicle means a vehicle which travels on the same lane and just in front of the own vehicle. The above-described lane next to the own vehicle's traveling lane means a lane which is adjacent to the traveling lane of the own vehicle. Herein, a vehicle speed control device corresponds to the throttle 9, the brake 11, and the controller 13.

To an input side of the controller 13 are connected the laser-radar sensor 3, VICS receiver 5, vehicle speed sensor 7 and the like, and to an output side thereof are connected the throttle 9, brake 11 and the like. The controller 13 performs the auto-cruising control in its mode which adjusts actuators of the throttle 9 and brake 11 or the like so as to control the own vehicle' speed at a target vehicle speed which has been set (hereinafter, referred to as “set speed”). The auto-cruising mode and the set speed are set, for example, by the driver with some specified operations. A specified vehicle speed according to the present invention corresponds to “the set speed”.

Further, the controller 13 comprises a traffic congestion determiner 15 operative to determine whether the traffic congestion occurs or not on the next lane, a cutting-into probability calculator 17 which calculates a probability (hereinafter, referred to as “cutting-into probability”) of another vehicle traveling on the next lane cutting into the traveling lane of the own vehicle when it is determined by the traffic congestion determiner 15 that the traffic congestion occurs on the next lane, and an adjuster 19 operative to reduce the set speed when it is determined by the traffic congestion determiner 15 that the traffic congestion occurs on the next lane. Herein, a traffic congestion determining device according to the present invention corresponds to the traffic congestion determiner 15, a cutting-into probability calculating device according to the present invention corresponds to the cutting-into probability calculator 17, and an adjusting device according to the present invention corresponds to the adjuster 19.

The traffic congestion determiner 15 determines whether or not the traffic congestion occurs based on the road traffic information and the like received from the VICS receiver 5.

The cutting-into probability calculator 17 calculates the cutting-into probability of the vehicle traveling on the next lane cutting into jut in front of the own vehicle based on a distance of the traffic congestion on the next lane, a time elapsed after the traffic congestion has occurred on the next lane, a speed difference between the own vehicle's speed and a peed of the another vehicle traveling on the next lane, and a vehicle-to-vehicle distance between the own vehicle and a vehicle which travels on the same lane and in front of the own vehicle. The above-described traffic congestion distance and time elapsed are considered parameters which are relevant to a mental state of a driver of the vehicle traveling on the next lane who may want to cut into to get out of the traffic congestion. The above-described speed difference and vehicle-to-vehicle distance are considered parameters which are relevant to the mental state of the driver of the vehicle traveling on the next lane who may decide a timing of the cutting-into. Also, the traffic congestion distance and time elapsed are obtained based on the road traffic information from the VICS receiver 5 and the like, the speed deference is obtained based on detecting results of the laser-radar sensor 3 and the vehicle speed sensor 7, and the vehicle-to-vehicle distance is obtained based on detecting results of the laser-radar sensor 3.

Specifically, the cutting-into probability calculator 17 calculates the cutting-into probability based on the following equation (1).
F=a·L+b·T+c·V+d·R (1)

Herein, F is the cutting-into probability, L is the traffic congestion distance, T is the time elapsed, V is the speed difference, R is the vehicle-to-vehicle distance. Also, a, b, c and d are constant values to satisfy relationships of a>b>c>d.

The above-described adjuster 19 reduces the set speed based on the cutting-into probability calculated by the cutting-into probability calculator 17 when it is determined by the traffic congestion determiner 15 that the traffic congestion occurs on the next lane. Specifically, for example, the adjuster 19 reduces the set speed by 10 km/h when the cutting-into probability is small, reduces the set speed by 20 km/h when the cutting-into probability is middle, reduces the set speed by 30 km/h when the cutting-into probability is large. The range of the small, middle and large cutting-into probability are set previously.

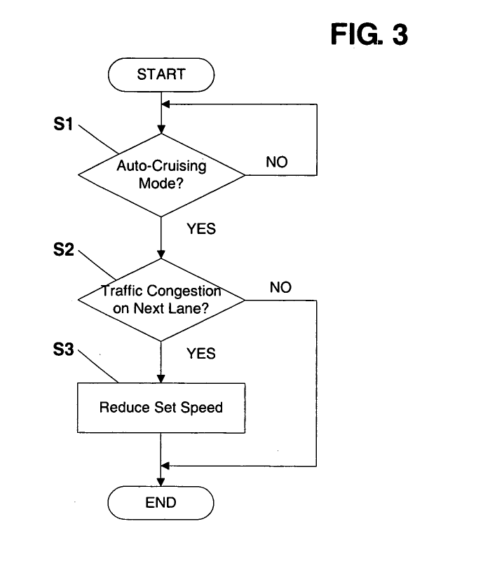

Hereinafter, the control processing of the traveling control device 1 will be described referring to FIG. 1 and a flowchart of FIG. 3. At first, in step S1, it is determined whether or not the own vehicle travels in the auto-cruising mode. When the answer to the step S1 is YES, the control sequence proceeds to step S2. When the answer is NO, the control sequence returns to a start.

In the step S2, it is determined whether or not the traffic congestion occurs on the next lane. When the answer to the step S2 is YES, the control sequence proceeds to step S3, and when the answer is NO, it returns to the start.

In the step S3, the set speed is reduced by a certain speed which corresponds to the calculated cutting-into probability, and the actuators to adjust the throttle 9 and brake 11 are controlled respectively so as to maintain the vehicle speed at the reduced set speed. Thereby, the own vehicle travels at the constant speed of the reduced set speed. After the vehicle has passed the portion of traffic congestion portion of the next lane, the vehicle's speed is controlled so as to be maintained at an original set speed.

According to the present embodiment described above, since the adjuster 19 reduces the set speed when the controller 13 performs the auto-cruising control and it is determined by the traffic congestion determiner 15 that the traffic congestion occurs on the next lane, the controller 13 controls the own vehicle's speed at the reduced set speed. Thus, the crash against the cutting-into vehicle from the next lane can be properly avoided, without operating the accelerator, brake 11, or steering handle, when the auto-cruising control is performed and the traffic congestion occurs on the next lane. Accordingly, the safety of the own vehicle when the controller 13 performs the auto-cruising control can be improved.

Generally, the probability of another vehicle traveling cutting into the own vehicle's traveling lane from the next lane with the traffic congestion is considered influenced by the driver's mental state.

According to the present embodiment described above, the cutting-into probability calculator 17 calculates the probability of another vehicle traveling on the next lane cutting into the own vehicle's traveling lane when it is determined by the traffic congestion determiner 15 that the traffic congestion occurs on the next lane, and the adjuster 19 reduces the set speed based on the probability calculated by the cutting-into probability calculator 17 when it is determined by the traffic congestion determiner 15 that the traffic congestion occurs on the next lane. Accordingly, the controller 13 can perform the auto-cruising control which is suitable to the driver's mental state of the vehicle traveling on the next lane with the traffic congestion.

### Embodiment 2

The present embodiment is different from the above-described embodiment 1 in a adjusting manner of the set speed by the adjuster 19. Namely, for example, the adjuster 19 changes the set speed to 60 km/h when the cutting-into probability F is small, changes the set speed to 50 km/h when the cutting-into probability F is middle, and changes the set speed to 40 km/h when the cutting-into probability F is large. Also, if the actual speed of the own vehicle is below the set speed, the adjuster 19 does not change the set speed. Others are substantially the same as the embodiment 1.

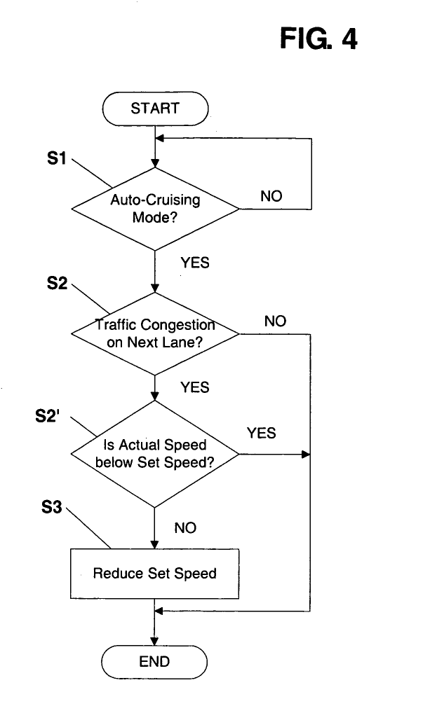

Hereinafter, the control processing of the traveling control device 1 will be described referring to FIG. 1 and a flowchart of FIG. 4. At first, in step S1, it is determined whether or not the own vehicle travels in the auto-cruising mode. When the answer to the step S1 is YES, the control sequence proceeds to step S2. When the answer is NO, the control sequence returns to a start.

In the step S2, it is determined whether or not the traffic congestion occurs on the next lane. When the answer to the step S2 is YES, the control sequence proceeds to step S2′, and when the answer is NO, it returns to the start.

In the step S2′, it is determined whether or not the actual speed of the own vehicle is below the set speed to be changed. When the answer to the step S2′ is NO, the control sequence proceeds to step S3, and when the answer is YES, it returns to the start.

In the step S3, the set speed is reduced and changed to the set speed which corresponds to the calculated cutting-into probability and the actuators to adjust the throttle 9 and brake 11 are controlled respectively so as to maintain the vehicle speed at the changed set speed. Thereby, the own vehicle travels at the constant speed of the reduced set speed. After the vehicle has passed the portion of traffic congestion portion of the next lane, the vehicle's speed is controlled so as to be maintained at the original set speed.

According to the present embodiment, the same function and effect as those of the embodiment 1 are obtained.

### Embodiment 3

In the present embodiment, the controller 13 performs, not the auto-cruising control but the so-called following-traveling control. Namely, the controller 13 sets a target vehicle-to-vehicle distance between the own vehicle and the vehicle traveling in front of the own vehicle in the following-traveling mode, and the controller 13 adjusts the actuators of the throttle 9 and the brake 11 and the like in such a manner that the vehicle-to-vehicle distance between the own vehicle and the vehicle traveling in front is equal to the set target vehicle-to-vehicle distance. That is, the controller 13 adjusts the actuators of the throttle 9 and the brake 11 and the like in such a manner that the own vehicle's speed is equal to the same speed as the vehicle traveling in front of the own vehicle. For example, the controller 13 adjusts the actuators of the throttle 9 and the brake 11 and the like so that the own vehicle's speed is equal to 80 km/h when the following-traveling control is performed and the vehicle in front travels at the speed of 80 km/h. A following-traveling control mode is set, for example, by the driver with some specified operations. Others are substantially the same as the embodiment 1. The specified vehicle speed according to the present invention corresponds to the “the same speed as the vehicle traveling in front.”

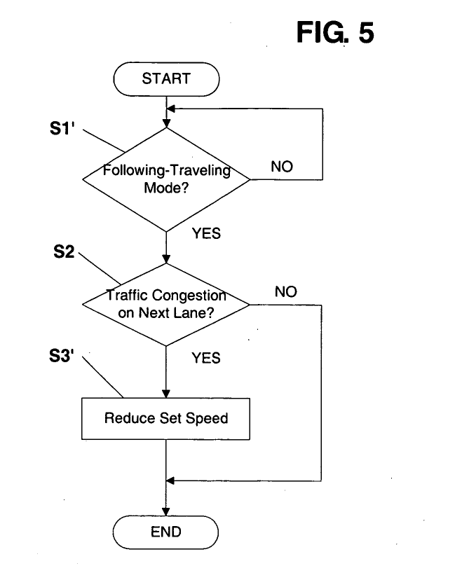

Hereinafter, the control processing of the traveling control device 1 will be described referring to FIG. 1 and a flowchart of FIG. 5. At first, in step S1′, it is determined whether or not the own vehicle travels in the following-traveling mode. When the answer to the step S1′ is YES, the control sequence proceeds to step S2. When the answer is NO, the control sequence returns to a start.

In the step S2, it is determined whether or not the traffic congestion occurs on the next lane. When the answer to the step S2 is YES, the control sequence proceeds to step S3′, and when the answer is NO, it returns to the start.

In the step S3′, the actuators to adjust the throttle 9 and brake 11 are controlled respectively so that the own vehicle's speed reduces to a speed which is smaller than the speed of the vehicle traveling in front of the own vehicle by a certain value which corresponds to the cutting-into probability. Thereby, the own vehicle travels at the constant speed which is lower than the speed of the vehicle traveling in front of the own vehicle. After the vehicle has passed the portion of traffic congestion portion of the next lane, the following-traveling control with the original target vehicle-to-vehicle distance is performed.

According to the present embodiment, the same function and effect as those of the embodiment 1 are obtained.

### Other Embodiments

Although the set speed are adjusted as described above in the respective embodiments described above, the set speed may be adjusted differently.

Also, although the cutting-into probability is calculated based on the equation (1) in the respective embodiments described above, it may be obtained by different manners.

Further, although the set speed is reduced based on the cutting-into probability in the respective embodiments described above, for example, it may be reduced only when the cutting-into probability of the vehicle traveling on the next lane is higher than a specified probability.

Also, the auto-cruising control or the following-traveling control are performed in the respective embodiments described above, these both controls may be performed at the same time.

The present invention should not be limited to the above-described embodiments and modified characteristics, but any other modifications and improvements may be applied within the scope of a sprit of the present invention.

What is claimed is:

1. A traveling control device of a vehicle, comprising:
a vehicle speed control device operative to control a vehicle speed of an own vehicle so as to be set at a specified vehicle speed;
a traffic congestion determining device operative to determine whether a traffic congestion occurs or not on a lane which is next to a traveling lane of the own vehicle; and
an adjusting device operative to reduce the specified vehicle speed controlled by said vehicle speed control device when it is determined by said traffic congestion determining device that the traffic congestion occurs on the next lane.

2. The traveling control device of a vehicle of claim 1, further comprising a cutting-into probability calculating device which calculates a probability of another vehicle traveling on the next lane cutting into the traveling lane of the own vehicle when it is determined by said traffic congestion determining device that the traffic congestion occurs on the next lane,
wherein said adjusting device is constituted so as to reduce the specified vehicle speed controlled by said vehicle speed control device based on the probability calculated by said cutting-into probability calculating device when it is determined by said traffic congestion determining device that the traffic congestion occurs on the next lane.

3. The traveling control device of a vehicle of claim 1, wherein said vehicle speed control device is constituted so as to control the own vehicle's speed at a target vehicle speed which is set as said specified vehicle speed.

4. The traveling control device of a vehicle of claim 1, wherein said vehicle speed control device is constituted so as to control the own vehicle's speed in such a manner that a vehicle-to-vehicle distance between the own vehicle and a vehicle which travels on the same lane and in front of the own vehicle is equal to a target vehicle-to-vehicle distance.

5. The traveling control device of a vehicle of claim 2, wherein said cutting-into probability calculating device is constituted so as to calculate the probability based on a distance of the traffic congestion on the next lane.

6. The traveling control device of a vehicle of claim 2, wherein said cutting-into probability calculating device is constituted so as to calculate the probability based on a time elapsed after the traffic congestion has occurred on the next lane.

7. The traveling control device of a vehicle of claim 2, wherein said cutting-into probability calculating device is constituted so as to calculate the probability based on a speed difference between the own vehicle's speed and a peed of the another vehicle traveling on the next lane.

8. The traveling control device of a vehicle of claim 2, wherein said cutting-into probability calculating device is constituted so as to calculate the probability based on a vehicle-to-vehicle distance between the own vehicle and a vehicle which travels on the same lane and in front of the own vehicle.
